(19) United States
(12) Patent Application Publication
(10) Pub. No.: US 2026/0061495 A1
(43) Pub. Date: Mar. 5, 2026

(54) MOLTEN METAL DISPENSING SYSTEMS AND METHODS FOR ADDITIVE MANUFACTURING IN SPACE

(71) Applicant: Blue Origin, LLC, Kent, WA (US)

(72) Inventor: Weidong Song, Woodinville, WA (US)

(21) Appl. No.: 18/825,935

(22) Filed: Sep. 5, 2024

(51) Int. Cl. B22F 12/58; B22F 12/13; B22F 12/90; B33Y 30/00; B33Y 50/02; C22B 9/02

(52) U.S. Cl. CPC B22F 12/58; B22F 12/13; B22F 12/90; B33Y 30/00; B33Y 50/02; C22B 9/023

(57) ABSTRACT

Molten metal dispensing systems and techniques for additive manufacturing in space are provided. In one aspect, a molten metal dispensing system includes a cartridge including a channel extending from a first end of the cartridge to a second end of the cartridge, the channel configured to receive a metal bar at the second end of the cartridge. The system also includes a filter positioned adjacent to the first end of the cartridge, a heater configured to melt a portion of the metal bar at the first end of the cartridge, an actuator configured to apply a force to the metal bar to move the metal bar towards the first end of the cartridge. The movement of the metal bar pushes the melted portion of the metal bar through the filter to dispense the melted portion of the metal bar.

### BACKGROUND

### Technical Field

The described technology relates generally to additive manufacturing and, in particular, to systems and techniques that can dispense molten metal for additive manufacturing in space.

### Description of the Related Technology

Methods of manufacturing large structures for use in space typically involve building numerous small sized modular parts that are assembled on earth and launched into orbit. In particular, it is often desirable to deploy structures in space that are more massive than the weight constraints for payloads that can be launched from the Earth using standard rocket technology. Thus, these large structures are often designed to be constructed from small sized modular parts that can be divided into multiple payloads to meet the weight constraints associated with launching the parts from the Earth. The use of small sized modular parts can limit the size of the structures that are manufactured in space and increase the manufacturing and/or shipping costs of assembling large structures in space.

### SUMMARY OF CERTAIN INVENTIVE ASPECTS

The embodiments disclosed herein each have several aspects, no single one of which is solely responsible for the present disclosure's desirable attributes. Without limiting the scope of the present disclosure, its more prominent features will now be briefly discussed. After considering this discussion, and particularly after reading the section entitled “Detailed Description” one will understand how the features of the embodiments described herein provide advantages over existing methods of manufacturing large space habitats.

In one aspect, a molten metal dispensing system is provided. The molten metal dispensing system includes a cartridge including a channel extending from a first end of the cartridge to a second end of the cartridge, the channel configured to receive a metal bar at the second end of the cartridge; a filter positioned adjacent to the first end of the cartridge; a heater configured to melt a portion of the metal bar at the first end of the cartridge; and an actuator configured to apply a force to the metal bar to move the metal bar towards the first end of the cartridge, the movement of the metal bar pushing the melted portion of the metal bar through the filter to dispense the melted portion of the metal bar.

In some embodiments, the channel has a rectangular or square cross-section.

In some embodiments, the filter has a cross-sectional area that is larger than a cross-sectional area of an opening of the channel at the first end of the cartridge.

In some embodiments, the molten metal dispensing system further includes a metal bar holder configured to feed metal bars into the second end of the channel of the cartridge.

In some embodiments, the molten metal dispensing system further includes a front guide configured to at least partially contain the melted portion of the metal bar dispensed through the filter.

In some embodiments, the front guide is further configured to: contact a surface of a substrate as the molten metal dispensing system is advanced across the surface of the substrate, and space the filter apart from the surface of the substrate.

In some embodiments, a distance between the filter and the substrate is adjustable.

In some embodiments, the front guide has an open end forming a space through which molten metal is dispensed to allow the melted metal to leave the front guide.

In some embodiments, the filter includes a ceramic material.

In some embodiments, the filter includes layers of woven fabric.

In some embodiments, the molten metal dispensing system is configured to be advanced across the surface of a substrate to deposit a strip of the melted portion of the metal bar having a thickness of about 1 mm.

In some embodiments, the filter is configured to break down a surface tension of the molten metal to dispense a substantially uniform layer of the molten metal on a substrate.

In some embodiments, the heater includes a heating element embedded within a dispensing tip of the cartridge.

In some embodiments, the heating element includes an induction coil or a resistive heater.

In some embodiments, the heater includes a thermometer configured to measure a temperature of the melted portion of the metal bar.

In some embodiments, the heater is configured to adjust an amount of heat applied to the metal bar using the temperature measured by the thermometer.

In some embodiments, the metal bar includes a first material, the channel is further configured to receive a second metal bar that includes a second material that is different than the first material, and the heater is configured to heat the first metal bar and the second metal bar to different temperatures.

In another aspect, a method of dispensing a molten metal is provided. The method includes feeding a metal bar into a cartridge of a molten metal dispensing system, the cartridge including a channel extending from a first end of the cartridge to a second end of the cartridge; melting a portion of the metal bar into a molten metal at the first end of the cartridge; and depositing the molten metal in layers on a substrate by pushing the molten metal through a filter positioned between the first end of the cartridge and the substrate.

In some embodiments, the method further includes applying a force to the metal bar within the channel using an actuator, the force configured to move the metal bar toward the first end of the cartridge, such that the movement of the metal bar pushes the molten metal through the filter.

In some embodiments, the portion of the metal bar is melted by an induction coil disposed at or near the first end of the cartridge.

In some embodiments, the method further includes, using a front guide of the molten metal dispensing system, preventing molten metal being dispensed through the filter from spreading in a direction the molten metal dispensing system is advancing over the structural liner and in a direction perpendicular to the direction the molten metal dispensing system is advancing over the structural liner.

In some embodiments, the method further includes replacing the front guide with a second front guide having a different width; and depositing additional layers of the molten metal with the second front guide.

In some embodiments, the method further includes moving the molten dispensing system over the substrate to deposit a strip of the molten metal on the substrate.

In some embodiments, the method further includes depositing a plurality of strips of the molten metal next to each other on the substrate to form the layers of the molten metal.

In some embodiments, at least one of the layers of the molten metal is formed on top of another one of the layers of molten metal.

In some embodiments, the method further includes adjusting a distance between the filter and the substrate to vary a thickness of the layers of the molten metal.

In some embodiments, the filter is configured to break down a surface tension of the molten metal to dispense a substantially uniform layer of the molten metal on a substrate.

In some embodiments, melting the portion of the metal bar includes heating the portion of the metal bar using a heating element embedded within a dispensing tip of the cartridge.

In some embodiments, melting the portion of the metal bar includes applying heat to the metal bar using an induction coil or a resistive heater.

In some embodiments, the method further includes measuring a temperature of the melted portion of the metal bar.

In some embodiments, the method further includes adjusting an amount of heat applied to the metal bar using the measured temperature.

In some embodiments, the metal bar includes a first material, the cartridge is further configured to receive a second metal bar that includes a second material that is different than the first material, and the method further includes heating the first metal bar and the second metal bar to different temperatures.

In yet another aspect, a method of manufacturing a structure is provided. The method includes attaching a structural liner to an internal wall of an inflatable bladder; deploying the inflatable bladder and the structural liner by pressurizing the inflatable bladder; and depositing a metallic structural shell on the structural liner using a molten metal dispensing system by moving the molten metal dispensing system over the structural liner, the molten metal dispensing system including a channel configured to hold a metal bar, a heater configured to melt a portion of the metal bar, and an actuator configured to apply a force to the metal bar to dispense the melted portion of the metal bar.

In some embodiments, moving the molten metal dispensing system includes sequentially depositing a plurality of metallic layers on the structural liner.

In some embodiments, depositing the metallic structural shell on the structural liner includes dispensing the melted portion of the metal bar through a ceramic filter disposed between the channel and the structural liner when the molten metal dispensing system is moved over the structural liner.

In some embodiments, the method further includes, using a front guide of the molten metal dispensing system, preventing molten metal being dispensed through the ceramic filter from spreading in a direction the molten metal dispensing system is advancing over the structural liner and in a direction perpendicular to the direction the molten metal dispensing system is advancing over the structural liner.

In some embodiments, the structural liner is a braided carbon fiber liner.

In some embodiments, deploying the inflatable bladder and the structural liner and depositing the metallic structural shell on the structural liner occurs in space.

In still another embodiment, a kit for manufacturing a structure is provided. The kit includes an inflatable bladder having an internal wall configured to define an internal space when the bladder is inflated; a structural liner configured to be attached to the internal wall of the inflatable bladder; and a molten metal dispensing system configured to deposit a metallic structural shell on the structural liner by moving the molten metal dispensing system over the structural liner, the molten metal dispensing system including a channel configured to hold a metal bar, a heater configured to melt a portion of the metal bar, and an actuator configured to apply a force to the metal bar to dispense the melted portion of the metal bar.

In some embodiments, the molten metal dispensing system further includes a filter positioned adjacent to an end of the channel, the melted portion of the metal bar being pushed through the filter before being dispensed.

In some embodiments, the filter has a cross-sectional area that is larger than a cross-sectional area of an opening of the channel at the end of the channel.

In some embodiments, the molten metal dispensing system further includes a front guide configured to prevent molten metal being dispensed from spreading in a direction the molten metal dispensing system is advancing over the structural liner and in a direction perpendicular to the direction the molten metal dispensing system is advancing over the structural liner.

In some embodiments, the structural liner is a braided carbon fiber liner.

In some embodiments, the inflatable bladder and the structural liner are configured to be deployed in space and the metallic structural shell is configured to be deposited on the structural liner in space.

In some embodiments, moving the molten metal dispensing system includes sequentially depositing a plurality of metallic layers on the structural liner.

In still a further embodiment, a structure is provided. The structure includes an inflatable bladder having an internal wall configured to define an internal space when inflated; a structural liner coupled to the internal wall of the inflatable bladder; and a metallic structural shell deposited by a molten metal dispensing system, the molten metal dispensing system including a channel configured to hold a metal bar, a heater configured to melt a portion of the metal bar, and an actuator configured to apply a force to the metal bar to dispense the melted portion of the metal bar.

In some embodiments, the molten metal dispensing system further includes a filter positioned adjacent to an end of the channel, the melted portion of the metal bar being pushed through the filter before being dispensed.

In some embodiments, the structural liner is a braided carbon fiber liner.

In some embodiments, the inflatable bladder and the structural liner are configured to be deployed in space and the metallic structural shell is configured to be deposited on the structural liner in space.

In some embodiments, the metallic structure is formed from a plurality of layers of the melted portion of the metal bar dispensed by the molten metal dispensing system.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. In some drawings, various structures according to embodiments of the present disclosure are schematically shown. However, the drawings are not necessarily drawn to scale, and some features may be enlarged while some features may be omitted for the sake of clarity. The relative dimensions and proportions as shown are not intended to limit the present disclosure. It will be readily understood that the aspects of the present disclosure, as generally described herein, and illustrated in the figures, can be arranged, substituted, combined, and designed in a wide variety of different configurations, all of which are explicitly contemplated and make part of this disclosure.

FIG. 1 is a side view of a molten metal dispensing system in accordance with aspects of this disclosure.

FIG. 2 is a cross-sectional view of the molten metal dispensing system in accordance with aspects of this disclosure.

FIG. 3 is a perspective view of a front guide in accordance with aspects of this disclosure.

FIG. 4 is a side view of the front guide in accordance with aspects of this disclosure.

FIG. 5 is a top view of the front guide in accordance with aspects of this disclosure.

FIG. 6 is a cross-section taken along the dashed line shown in FIG. 3 in accordance with aspects of this disclosure.

FIG. 7 is a perspective view of the front guide with a cartridge removed to show features of the front guide in more detail in accordance with aspects of this disclosure.

FIG. 8 is another perspective view of the front guide with the cartridge removed to show features of the front guide in more detail in accordance with aspects of this disclosure.

FIGS. 9A and 9B are perspective views of embodiments of a metal bar in accordance with aspects of this disclosure.

FIG. 10 illustrates a method of dispensing a molten metal in accordance with aspects of this disclosure.

FIG. 11 illustrates a structure that can be constructed with additive manufacturing using a molten metal dispensing system in accordance with aspects of this disclosure.

FIG. 12 illustrates the structure including a structural shell constructed using the molten metal dispensing system in accordance with aspects of this disclosure.

FIG. 13 illustrates a method of manufacturing a structure in accordance with aspects of this disclosure.

### DETAILED DESCRIPTION

Aspects of this disclosure relate to systems and techniques for applying molten metal in layers on a substrate or other surface. Multiple layers of the molten metal can be successively deposited to form structures, such as a structural shell, in an additive manner. As described herein, a molten metal dispensing system can be used to apply the molten metal using techniques that are similar to painting and/or brushing. In one example, the molten metal dispensing system applies a strip of molten metal in a thin layer as it passes over a substrate, similar to how a paint brush applies a strip of paint in a thin layer as it passes over a surface.

The molten metal dispensing systems described herein can be used to construct any type of metal structure that can be fabricated using additive manufacturing. One example application is the manufacturing of a structural shell, which can be used to build large space habitats directly in space. For example, the structural shell can be deposited on a deployable structural liner that provides an initial shape for the structural shell.

Advantageously, the additive manufacturing systems and techniques described herein can produce structures that have fewer defects, in part due to the vacuum of space, when compared to manufacturing techniques performed under atmospheric pressures. Traditional methods of manufacturing large structures in space involve building numerous small sized modular parts that are assembled on Earth and launched into orbit. These small sized modular parts are needed because of the weight constraints for launching payloads from Earth. The use of small sized modular parts can limit the size of the structures that are manufactured in space and increase the manufacturing and/or shipping costs of assembling larger structures in space. In contrast, the additively-manufactured systems according to aspects of this disclosure can be constructed and/or used in space, rather than being launched from the Earth, removing the constraints associated with payload sizes.

Further aspects of this disclosure can be used to apply various metals and metal matrix composites on fabric materials to form highly efficient structures in space. The described technology can open the door to many capabilities that previously did not exist. For example, the described technology can enable large scale additive manufacturing of large space habitat pressure vessels directly in space in part by eliminating constraints imposed by launch vehicles. Aspects of this disclosure can also be used as a high-rate additive technology on Earth. Example Earth-based applications include the automotive industry and the ship building industry.

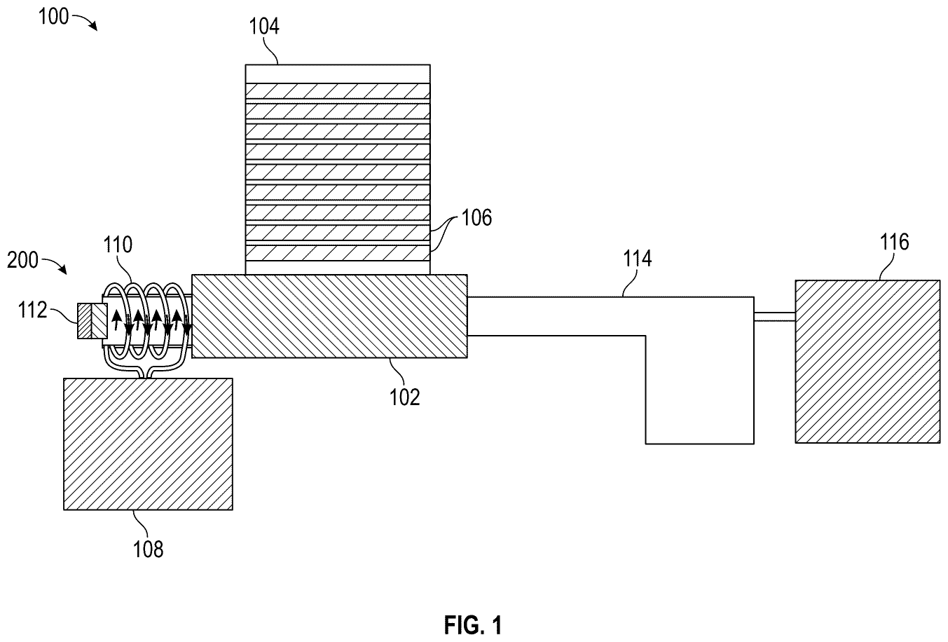

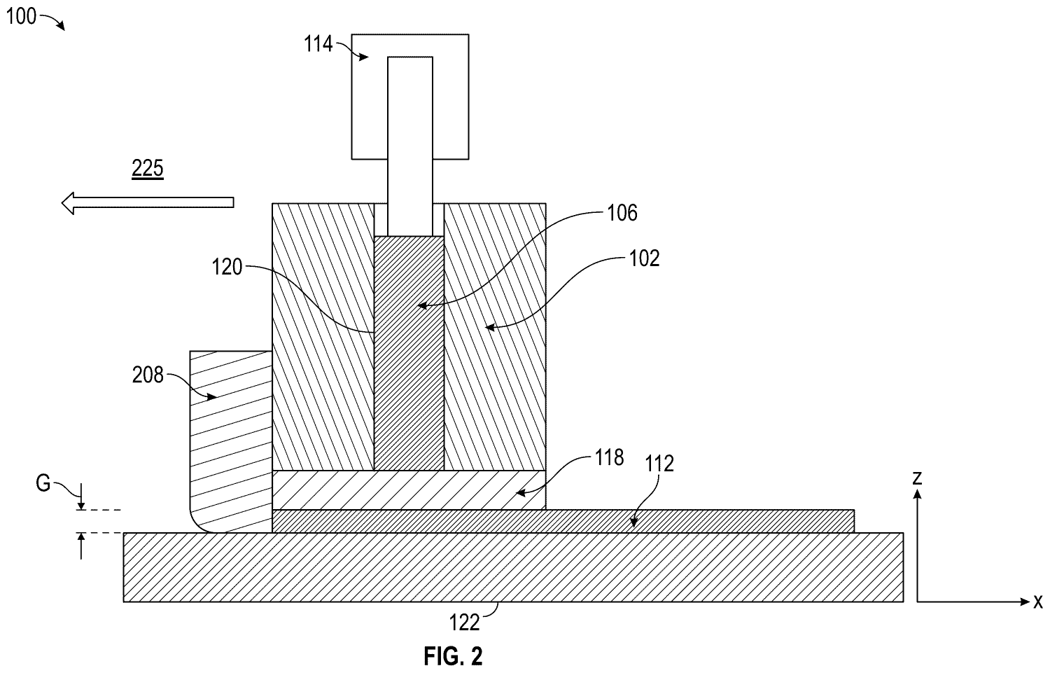

FIG. 1 is a side view of a molten metal dispensing system 100 in accordance with aspects of this disclosure. FIG. 2 is a cross-sectional view of the molten metal dispensing system 100 in accordance with aspects of this disclosure. Certain components of the molten metal dispensing system 100 may be omitted from one or more of FIGS. 1 and 2 in order to simplify the illustrated views.

As shown in FIGS. 1 and 2, the molten metal dispensing system 100 includes a cartridge 102, a metal bar holder 104 (also referred to as a “feeder”), a plurality of metal bars 106, a heater 108 including a heating element 110, an actuator 114, a power pack 116, a filter 118, and a front guide 208 (also referred to as a “deposition head”).

The metal bar holder 104 is configured to feed the metal bars 106 into the cartridge 102 one at a time. The cartridge 102 has a channel 120 configured to receive one of the metal bars 106 from the metal bar holder 104. The channel 120 may extend from a first end of the cartridge 102 (for example, at a dispensing tip 200 of the molten metal dispensing system 100) to a second end of the cartridge 102. The metal bars 106 can include different materials and/or combinations thereof, for example, aluminum, titanium, copper, an alloy of aluminum and titanium, an alloy of copper and titanium, and/or other alloys including aluminum and/or titanium, or any other feedstock material that can be melted and deposited in molten layers for additive manufacturing. The layers of molten metal can be applied as strips of metal on a surface. The metal bars 106 can be swapped for bars 106 of a different material or combination of materials depending on the structure being manufactured.

The heater 108 is configured to melt the metal bar 106 held in the cartridge 102 at a position at or near the dispensing tip 200 of the cartridge 102. In some embodiments, the heating element 110 can include an induction coil and/or a resistive heater to melt the metal bar 106. However, other heating elements 110 capable of melting the metal bar 106 can also be used without departing from aspects of this disclosure. In some embodiments, the heating element 110 can be embedded in the cartridge 102 within the dispensing tip 200 to melt only the portion of the metal bar 106 positioned near the dispensing tip 200. Thus, the heating element 110 can increase the temperature of the metal bar 106 above its melting point when the metal bar 106 reaches the end of the dispensing tip 200.

In some embodiments, the heater 108 can include a thermometer configured to monitor the temperature of molten metal 112 dispensed from the dispensing tip 200. The heater 108 can use the measured temperature to monitor and adjust the amount of heat applied to the metal bar 106 via the heating element 110 in a closed loop. The heater 108 can also be configured to heat the metal bar 106 to different temperatures depending on the particular material of the metal bar 106. For example, the heater 108 can heat aluminum metal bars 106 to about 600° C.

The filter 118 can be coupled to the dispensing tip 200 at the second end of the cartridge 102. For example, the filter 118 can be coupled to the cartridge 102 using a fastener or a bonding agent. In some embodiments, the filter 118 is configured to be coupled to the cartridge 102 such that the filter 118 can be easily removed and replaced. For example, the filter 118 can be mechanically coupled to the cartridge 102 using fasteners, clips, magnets, bolts, etc. The melted portion 112 of the metal bar 106 (also referred to simply as “molten metal”) can be pushed through the filter 118 before being applied to a substrate 122. The actuator 114 is arranged adjacent to the second end of the cartridge 102 and is configured to apply a force to the metal bar 106 held in the cartridge 102 to move the metal bar 106 toward the first end of the cartridge 102. The pressure resulting from the force applied to the metal bar 106 from the actuator 114 forces the molten metal 112 through the filter 118. That is, the movement of metal bar can assist in dispensing the molten metal 112 through the filter 118.

In micro-gravity environments, the surface tension of liquids, such as the molten metal 112, tends to form droplets since gravity is not working to press the droplets against the substrate 122. This can make it difficult to form a uniform layer of molten metal 112, since the molten metal 112 may quickly solidify before the droplets can be dispersed into a uniform layer. Accordingly, some embodiments of the molten metal dispensing system 100 include the filter 118 to break down the surface tension of the molten metal 112 and more readily form a uniform layer of the molten metal 112 on the substrate 122.

The filter 118 can also be configured to regulate the flow of the molten metal 112 that is dispensed from the cartridge 102. For example, the filter 118 can restrict the flow of molten metal 112 pressed through the filter 118 due to the force applied by the actuator 114, providing a more even flow of molten metal 112 from the dispensing tip 200. In some embodiments, the filter 118 may not filter out or remove any material from the molten metal 112, but rather provide a backpressure to regulate the flow of the molten metal 112 from the dispensing tip 200. Accordingly, the filter 118 can be implemented as a backpressure regulating material, a porous matrix, and/or any other medium that can regulate the flow of the molten metal 112 from the dispensing tip 200.

In some embodiments, the filter 118 is formed of a ceramic material. For example, the filter 118 can include a ceramic fabric through which the molten metal 112 is dispensed. Ceramics may be advantageous for use in the filter 118 as many ceramic materials will not chemically interact with the molten metal 112. For example, in some embodiments, the filter 118 can be formed of silicon carbide. Silicon carbide may be advantageous when depositing molten aluminum since silicon carbide will not chemically interact with the molten aluminum. Advantageously, ceramic materials can also handle high temperatures, are very durable, and are porous to allow the molten metal 112 to flow therethrough. Although ceramics are one advantageous material for the filter 118, other materials that are sufficiently porous, can handle high temperatures of the molten metal 112, can break the surface tension of the molten metal 112, and are sufficiently durable can also be used for the filter 118 without departing from aspects of this disclosure. In some embodiments, the porosity of the filter 118 can be designed based on a desired pressure of the molten metal 112 to select the flow rate of the molten metal 112 out of the dispensing tip 200.

After the molten metal dispensing system 100 has completed dispensing molten metal 112, the molten metal 112 present in the filter 118 will cool and solidify within the filter 118. In some embodiments, the filter 118 is formed of a sufficiently durable material (for example, ceramic) such that the solidified metal does not significantly damage the filter 118. When using the molten metal dispensing system 100 for another project, the solidified metal can be melted again using a heater.

In some embodiments, the filter 118 can be formed of a plurality of layers of ceramic fiber. These layers may be woven together to form a fabric. In some embodiments, each layer of ceramic fiber may be relatively thin. For example, each layer of ceramic material may have a thickness of about 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, or any value or range defined by any of the preceding values. In example embodiments, the filter 118 may include 10 layers, 20 layers, 30 layers, 40 layers, 50 layers, or more layers, or any value or range defined by any of the preceding values. In some embodiments, the total thickness of a filter 118 may be less than about 20 mm. For example, the filter may have a thickness of about 5 mm, 10 mm, 20 mm, or any value or range defined by any of the preceding values. In some embodiments, the filter 118 can include ceramic matrix composites.

The filter 118 can also be formed of felt, an aluminum oxide fiber, fiberglass, silicon oxide fiber, ceramic fiber, etc. Aluminum oxide fiber can withstand very high temperatures (for example, up to about 3500° F.). When formed of felt, the filter 118 can be formed of a plurality of layers of felt which are pressed together. In some embodiments, the felt may include voids that are substantially randomly distributed throughout a given layer of felt. In some embodiments, the layers of felt may be formed of aluminum oxide fibers.

Fiberglass is low cost and could be used to deposit aluminum but may not be useful for depositing higher temperature materials. For depositing certain metals, such as titanium and copper, relatively high temperatures may be required to melt the metals and ceramic fiber may be particularly suited for depositing these metals. Accordingly, the size and/or material of the components forming the molten metal dispensing system 100 can be selected based on the metal to be deposited.

As shown in FIG. 2, the front guide 208 is configured to space the filter 118 apart from the substrate 122 to form a gap with a distance G. By spacing the filter 118 a substantially constant distance G from the substrate 122, the molten metal dispensing system 100 can deposit a substantially uniform layer of molten metal 112 on the substrate 122. In some embodiments, the distance G may be about 1 mm, 0.5 mm, or any value in between these values. The front guide 208 can be configured to hold the filter 118 in place such that when the first end surface 252 (see FIG. 8) is in contact with the substrate 122, the filter 118 is spaced apart from the substrate 122 by the distance G. In some embodiments, the front guide 208 can be configured to adjust the distance G between the filter 118 and the substrate 122. In some embodiments, the front guide 208 can be configured to provide continuous adjustment (for example, stepless adjustment) of the distance G between the filter 118 and the substrate 122. In some embodiments, the front guide 208 can be threaded onto the cartridge 102 or the front guide 208 can be configured to move along the cartridge 102 and be fixed in place using one or more set screws.

The power pack 116 is configured to power the actuator 114 and/or the heater 108. Advantageously, the power pack 116 can be implemented in a smaller space and/or volume compared to other methods of generating force to be applied to the metal bar 106 in the cartridge 102. For example, certain techniques for generating a force may employ a pump, which is relatively large. Compared to other techniques, using the actuator 114 to apply a mechanical force to push the metal bar 106 through the cartridge 102 is a mass and energy efficient technique for moving the metal bar 106 and dispensing the molten metal 112 from the dispensing tip 200.

During use, the front guide 208 of the molten metal dispensing system 100 is configured to be placed against a substrate 122 such that the dispensing tip 200 is spaced apart from the substrate 122 by the distance G. The molten metal dispensing system 100 can be moved along the surface of the substrate 122 in the direction 225, leaving a strip of molten metal 112. The strip of molten metal 112 can have a volume defined by the length, width, and thickness of the strip. As described herein, the thickness of the strip may be proportional to the distance G that the filter 118 is spaced apart from the substrate 122. The width of the strip may be proportional to a width of an interior channel 229 of the front guide 208 (see, for example, the interior channel 229 illustrated in FIG. 7). The molten metal dispensing system 100 can deposit strips having any desirable length by continuing to dispense molten metal 112 as the molten metal dispensing system 100 is moved along the substrate 122.

In some embodiments, a plurality of strips of the molten metal 112 can be applied next to each other on the substrate 122 (for example, each strip of molten metal 112 can be applied onto the substrate 122 such that the lengths of the strips are parallel to each other) to form of a layer of molten metal 112. In some examples, the layer can take the form of a sheet, a coating, or a film of molten metal 112. In some embodiments, the dispensing tip 200 can deposit a plurality of layers on top of each other to increase the overall thickness of the deposited material.

The molten metal 112 may quickly solidify when no longer exposed to heat from the heating element 110. As discussed above, the filter 118 is configured to break down the surface tension of the molten metal 112 to provide a substantially uniform layer of molten metal 112 forming a strip of solidified metal as the molten metal dispensing system 100 is moved across the substrate 122. Because the molten metal dispensing system 100 is able to deposit a strip of solidified metal in the form of a substantially uniform layer, the molten metal dispensing system 100 can be used to deposit metal in a manner similar to painting and/or brushing. Thus, the molten metal dispensing system 100 can use similar techniques used for painting and/or brushing to manufacture metal structures.

After passing through the filter 118, the molten metal is deposited or “brushed” on the substrate 122. The molten metal 112 can subsequently cool and solidify to form a solid strip, with multiple strips being applied together to form a layer of metal. For example, a first strip of metal can be positioned adjacent to a second strip of metal to form a layer of metal having a substantially constant thickness. In some cases, the first strip of metal and the second strip of metal are both in direct contact with the substrate 122 (or in direct contact with underlying strip(s)). In addition or alternatively, the first strip of metal can be positioned below a third strip of metal to form a layer of metal having a total thickness that is greater than the thickness of either the first strip or the third strip. In some cases, the first strip of metal is sandwiched between the third strip of metal and the substrate 122. In other cases, the first strip of metal is sandwiched between the third strip of metal and another underlying strip. Accordingly, the molten metal dispensing system 100 can function like a hot glue gun, melting a portion of the metal bar 106 near the dispensing tip 200 and dispensing molten metal 112 which subsequently cools to form a strip of metal.

The front guide 208 can assist in confining the molten material to a deposition area and reduces or eliminates any overflow of molten metal outside of the desired deposition area. Additional layers of molten material can be deposited depending on the desired thickness of the structural shell or part being formed. Thus, a metal structure of virtually any shape or size can be manufactured by depositing additional layers of metal over the previously deposited layers.

The molten metal dispensing system 100 can be configured to deposit layers and/or strips of metal in varying widths (for example, measured in the y-direction as illustrated in FIGS. 5, 7, and 8), which can be adjusted based on the size of the opening in the channel 120 at the dispensing tip 200 and/or the shape of the front guide 208. For example, the deposited metal strips can have a width of 1 foot, 6 inches, 3 inches, 1 inch, ⅛ inch, 1/16 inch, or smaller, or any value or range defined by any of the preceding values. Smaller width metal strips can be used when manufacturing more detailed or fine structures, while larger width metal strips can be used when manufacturing larger structures such as structures in acreage areas. When depositing layers and/or strips having relatively larger widths, the metal bars 106 can have a substantially rectangular cross-section with the longer edge of the rectangular cross-section aligned with the width of the deposited layer/strip.

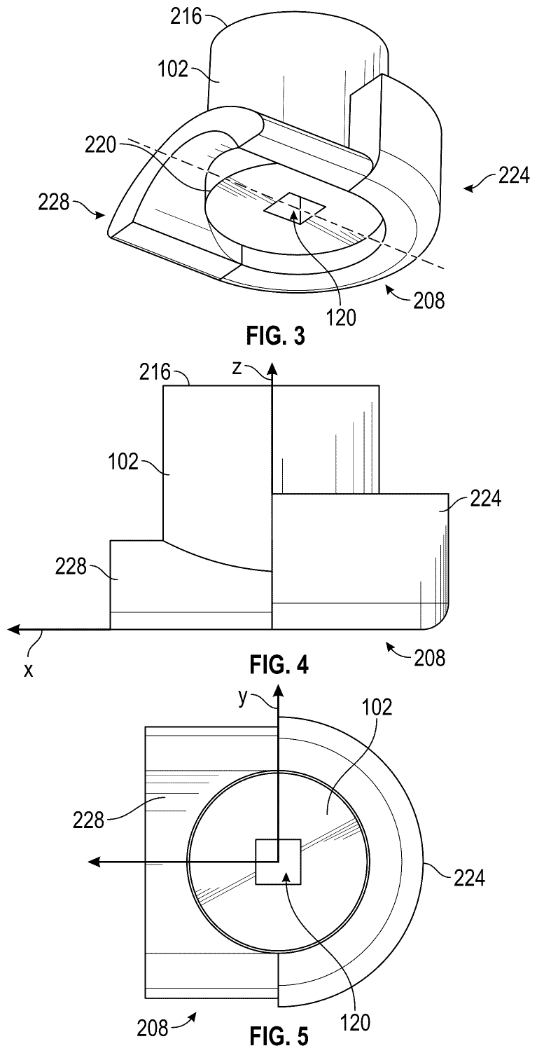

In some embodiments, the molten metal dispensing system 100 may be configured to deposit layers and/or strips of metal having varying thicknesses (for example, measured in the z-direction illustrated in FIGS. 3 and 8). For example, the thickness of a deposited strip may be based in part on the distance G defined by the gap between the filter 118 and the substrate 122. In some embodiments, the thickness of a strip of metal may be about 0.5 mm to 1 mm, or any value in between these values.

The molten metal dispensing system 100 can also be configured to deposit layers and/or strips of metal having substantially any length (for example, measured in the x-direction illustrated in FIGS. 4 and 8). For example, the only limits on the length of a given strip may be the size of the substrate 122 being deposited onto and/or the number of metal bars 106 available. Thus, the molten metal dispensing system 100 can be moved a distance substantially equal to the desired length of the strip being deposited while depositing molten metal 112 by melting one or more metal bars 106 to deposit the strip having the desired length.

### Example Front Guide

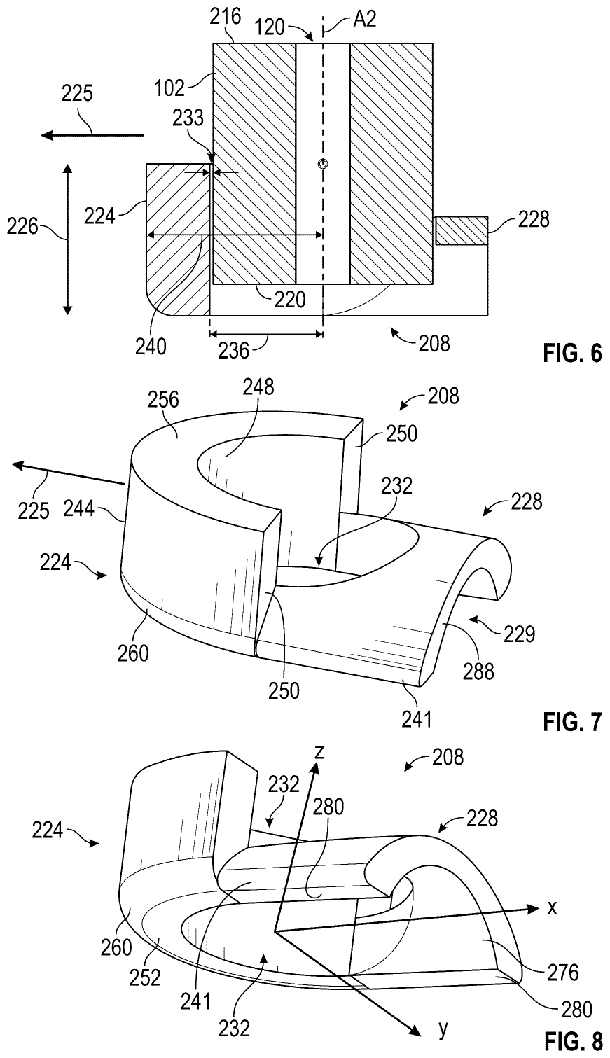

FIGS. 3-6 illustrate an example embodiment of a front guide 208 that can be coupled to the dispensing tip 200 of the cartridge 102 in accordance with aspects of this disclosure. FIG. 3 is a perspective view of the front guide 208, FIG. 4 is a side view of the front guide 208, FIG. 5 is a top view of the front guide 208, and FIG. 6 is a cross-section taken along the dashed line shown in FIG. 3. FIGS. 7 and 8 show the front guide 208 with the cartridge 102 removed. In FIGS. 4-8, the front guide 208 is illustrated without the filter 118 installed for ease of illustrating the features of the front guide 208.

The front guide 208 can be coupled to the cartridge 102 near the dispensing tip 200 of the cartridge 102. The cartridge 102 and the front guide 208 can be removably assembled. As described herein, the front guide 208 can contain and/or constrain the molten metal 112 so that the molten metal 112 does not overflow.

The cartridge 102 can include a channel 120. The channel 120 can extend between a first end 220 and a second end 216 of the cartridge 102. The channel 120 can have any shaped cross-section, for example circular, square, rectangular, or polygonal. The channel 120 can be centrally located in the cartridge 102. The channel 120 can extend along a central axis A2 (as shown in FIG. 6) of the cartridge 102. As described above, the channel 120 can be configured to hold a metal bar 106 that can be melted before being dispensed from the channel 120 to a deposition zone.

FIGS. 7 and 8 show the front guide 208 with the cartridge 102 removed to show features of the front guide 208 in more detail. The front guide 208 can control the deposition of the molten metal 112 in that the surfaces of the front guide 208 limit the movement of the molten metal 112 by providing boundaries that at least partially determine the dimensions of the deposited layer and/or strip of molten metal 112.

The front guide 208 can include a first portion 224 and a second portion 228. The first portion 224 can be separate from the second portion 228. The first portion 224 and the second portion 228 can be a single integral or unitary part. The first portion 224 can have a height extending in the direction of the z-axis (shown in FIGS. 4 and 8) that is greater than a height of the second portion 228 extending in the direction of the z-axis. The first portion 224 and the second portion 228 can form an open space 232 configured to receive and/or retain the cartridge 102. When the cartridge 102 is received within the open space 232 there can be a predetermined clearance 233 (shown in FIG. 6) between front guide 208 and the cartridge 102. However, in other embodiments, the cartridge 102 is received within the open space 232 without any clearance 233. In still other embodiments, the front guide and the cartridge are formed as a monolithic or unitary structure.

The first portion 224 can be semi-cylindrical in shape. For example, in some instances, the first portion 224 can be generally C-shaped. In some instances, the first portion 224 can have an arch shape. The first portion 224 can have an inner radius 236 and an outer radius 240 (as best shown in FIG. 6) relative to a first axis (for example, the z-axis as best shown in FIG. 8 or the central axis A2 as shown in FIG. 6). The outer radius 240 can define at least a portion of an outer curved surface 244 of the first portion 224. The outer curved surface 244 (as best shown in FIG. 7) can be referred to as the leading surface of the first portion 224 as it is the frontmost portion of the front guide 208 as it moves relative to a substrate. For example, the leading surface is the first portion to travel along a substrate 122 as the molten metal dispensing system 100 moves in a tool advance direction 225.

As best shown in FIG. 7, the inner radius 236 can define at least a portion of an inner curved surface 248 and at least a portion of the open space 232 formed by the first portion 224 and the second portion 228. In some instances, the inner radius 236 can define approximately half of a diameter of the open space 232. The outer and inner curved surfaces 244, 248 can extend a length 226 (as best shown in FIG. 6) vertically along the z-axis. The length 226 can extend at least partially adjacent the cartridge 102 in the direction of the z-axis. As best shown in FIG. 7, the part 224 can define in part first and second side surfaces 250 that connect the outer and inner curved surfaces 244, 248. The side surfaces 250 can be referred to as the trailing surfaces of the first portion 224 as they trail behind the leading surface of outer curved surface 244 as the front guide 208 moves along a substrate 122 in the tool advance direction 225.

The first portion 224 can have a first end surface 252 (as best shown in FIG. 8) and a second end surface 256 (as best shown in FIG. 7). The first end surface 252 can be configured to contact the surfaces of the substrate 122. The second end surface 256 can be opposite the first end surface 252 and face away from the substrate 122. The inner curved surface 248 and the outer curved surface 244 can be connected by the first end surface 252 and the second end surface 256.

The first end surface 252 of the first portion 224 can transition to the outer curved surface 244 via a curved edge 260, as best shown in FIG. 8. The curved edge 260 can have a predetermined radius of curvature. The curved edge 260 can be configured to minimize fretting on the substrate 122 onto which the molten metal 112 is deposited. The curved edge 260 allows for a smoother tool surface contacting the substrate 122, thus reducing fretting or wear and tear when the tool travels forward on the substrate 122 surface.

As best shown in FIGS. 7 and 8, the second portion 228 can be semi-cylindrical in shape, although in other embodiments the second portion 228 can have different shapes without departing from aspects of this disclosure. In some instances, the second portion 228 can be generally C-shaped, have a compressed or flattened C-shape, have an arch shape, or another shape. A concave surface of the second portion 228 can face downward toward the substrate 122 to define an area at least partially enclosed by the substrate 122 and the concave surface of the second portion 228. The front guide 208 can have first and second side surfaces 280 configured to contact the surfaces of substrate 122.

The second portion 228 can optionally have chamfered edges 241. The chamfered edges 241 can extend parallel to the x-axis, as best shown in FIG. 8. The second portion 228 has an open end configured to allow the filler material to exit the front guide 208. The open end can be formed by an interior channel or space 229, as best shown in FIG. 7. The interior channel 229 can be at least partially defined by the inner curved surface 276 and extend in the direction of the x-axis as shown.

Embodiments of the front guide 208 according to the present disclosure can provide many benefits and advantages. For example, the front guide 208 can produce consistent predictable profiles of the deposited molten metal 112. Consistent profiles and quality can case the additive manufacturing process and enable more efficient designs. Further, the front guide 208 can minimize molten metal 112 waste and eliminate any post processing after depositing a layer and/or strip of molten metal 112.

### Example Metal Bar Profiles

The metal bar 106 can have various different profiles or cross-sectional shapes depending on the particular embodiment. For example, the cross-section of the metal bar 106 can be shaped as a circle, square, a rectangle, etc.

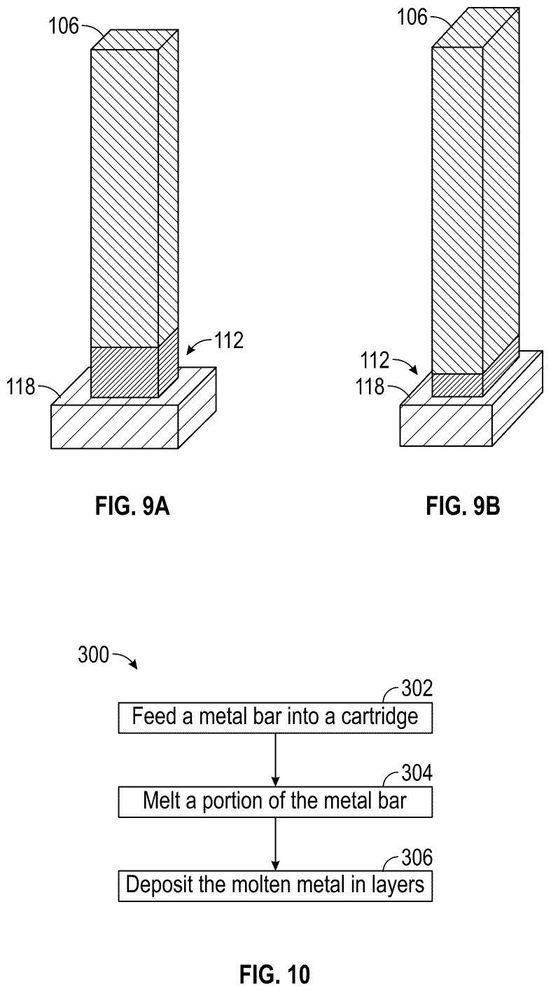

FIGS. 9A and 9B are perspective views of embodiments of the metal bar 106 in accordance with aspects of this disclosure. In particular, FIG. 9A illustrates an embodiment in which the metal bar 106 has a substantially square cross-section, while FIG. 9B illustrates an embodiment in which the metal bar 106 has a substantially rectangular cross-section. As shown in FIGS. 9A and 9B, the metal bar 106 can be heated at an end next to the filter 118 to produce molten metal 112.

Metal bars 106 having square or rectangular cross-sections may more efficiently stack in the metal bar holder (for example, the metal bar holder 104 of FIGS. 1 and 2) compared to metal bars 106 having a circular cross-section. That is, the material of the metal bars 106 may be more compactly stored within the metal bar holder for metal bars 106 having square or rectangular cross-sections.

In each of the FIGS. 9A and 9B embodiments, the filter 118 can have a cross-sectional area that is larger than the cross-sectional area of the metal bars 106 such that the molten metal 112 cannot leave the dispensing tip (see the dispensing tip 200 of FIG. 1) without passing through the filter 118. In some embodiments, the filter 118 may have substantially the same cross-sectional shape as the cross-sectional shape of the metal bars 106, however, aspects of this disclosure are not limited to these embodiments. The heights of the filter 118 illustrated in FIGS. 9A and 9B relative to the heights of the molten metal 112 are not intended to be limiting.

For certain applications, a metal bar 106 having a rectangular cross-section may be advantageous by improving heating efficiency. For example, by having a cross-section that is comparatively narrower along a first axis and wider along a second axis, the center portion of the metal bar 106 can be more easily heated since there is less distance for the heat to conduct through to reach the center. Another advantage to using a metal bar 106 having a rectangular cross-section for certain applications is that the metal bar 106 can cover a much wider print area with relatively light metal bars 106. Accordingly, the height of the molten metal 112 in the embodiment of FIG. 9B can be less than the height of the molten metal 112 in the embodiment of FIG. 9A while still melting the center of the metal bar 106.

### Example Methods for Dispensing Molten Metal

FIG. 10 illustrates a method 300 of dispensing a molten metal using a molten metal dispensing system in accordance with aspects of this disclosure. At block 302, the method 300 involves feeding a metal bar into a cartridge (for example, the metal bar holder 104 of the molten metal dispensing system 100 illustrated in FIGS. 1 and 2). The cartridge can include a channel (for example, the channel 120 illustrated in FIG. 2) extending from a first end of the cartridge to a second end of the cartridge.

At block 304, the method 300 involves melting a portion of the metal bar into a molten metal. For example, the portion of the metal bar can be melted by heater (for example, an induction coil) disposed at or near the first end of the cartridge. Thus, the metal bar can be melted near a dispensing tip (for example, the dispensing tip 200 of FIG. 1) of the molten metal dispensing system.

At block 306, the method 300 involves depositing the molten metal in layers on a substrate. The molten metal dispensing system can push the molten metal through a filter positioned between a first end of the cartridge and the substrate to deposit the molten metal on the substrate. For example, the molten metal dispensing system can apply a force on the metal bar within the channel using an actuator. The force applied to the metal bar can move the metal bar toward the first end of the cartridge, thereby pushing the molten metal through the filter. The force applied to the metal bar can result in a pressure applied to the molten metal such that the molten metal flows through the filter. The filter can regulate a pressure drop and flow rate of the molten metal, so that the molten metal can be brushed onto a surface using the molten metal dispensing system. The molten metal subsequently cools and forms a solid layer on the surface.

### Manufacture of Example Structures in Space

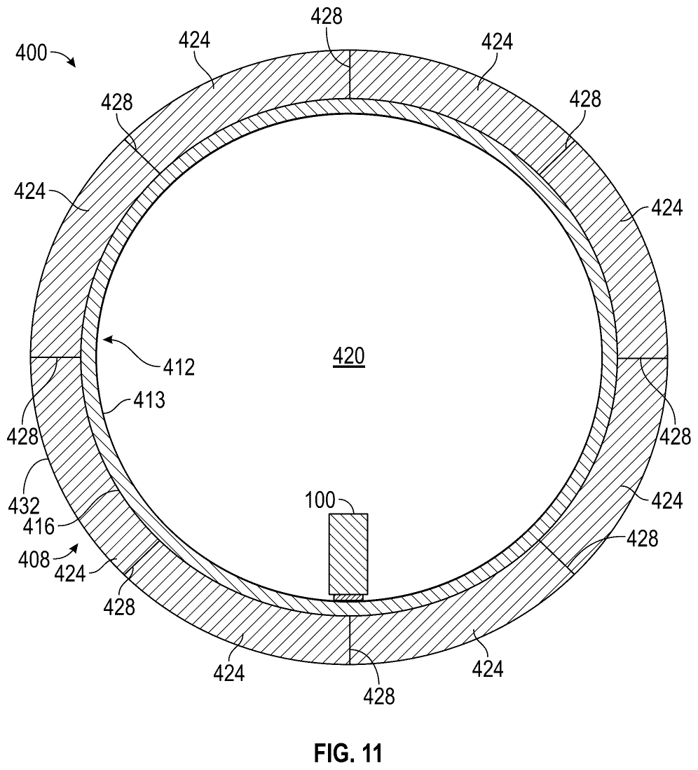

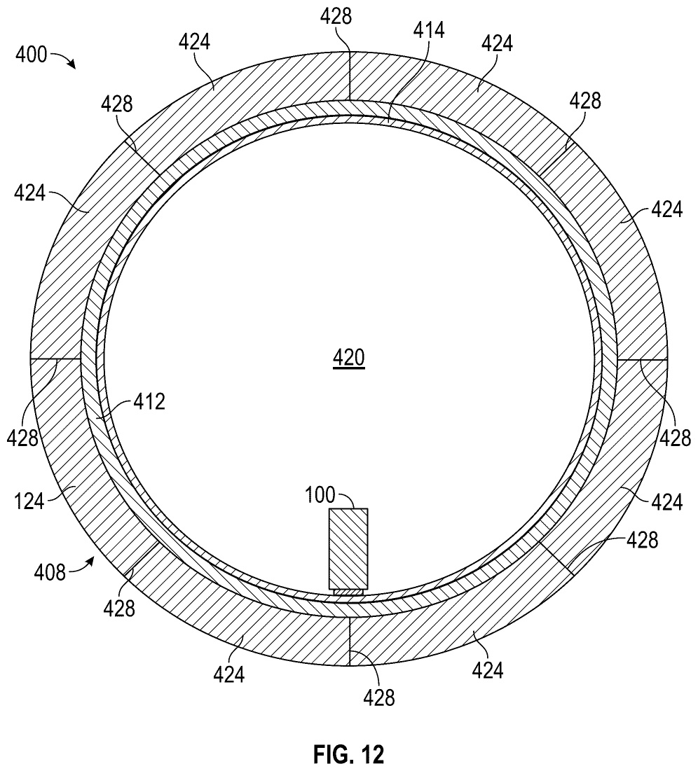

While the molten metal dispensing system 100 can be used to manufacture various different structures, one application for the molten metal dispensing system 100 is for manufacturing a structural shell for a space habitat pressure vessel. FIG. 11 illustrates a structure 400 that can be constructed with additive manufacturing using a molten metal dispensing system 100 in accordance with aspects of this disclosure. FIG. 12 illustrates the structure 400 including a structural shell 414 constructed using the molten metal dispensing system 100 in accordance with aspects of this disclosure.

Non-limiting examples of the structure 400 include large space habitats or vessels that can be manufactured in space. Parts and tools to manufacture the structure 400 can be packaged and delivered to space in a kit according to the present disclosure. The structure 400 may be connected to a space station or space vehicle prior to, during, and/or after manufacture of the structure 400. For example, the structure 400 can be attached to a space craft or space station via a connecting port (not illustrated).

The structure 400 may include an inflatable bladder 408 and a structural liner 412. The inflatable bladder 408 may have an internal wall 416 and an external wall 432. The internal wall 416 may define an internal space 420 when the inflatable bladder 408 is inflated. The inflatable bladder 408 may be connected to a gas source capable of inflating the bladder. When the inflatable bladder 408 is inflated or deployed, it may transform from a folded or packed configuration to an unfolded or unpacked configuration.

A vacuum condition may exist in the internal space 420. The vacuum condition may exist naturally or automatically without any outside intervention needed to create the vacuum environment. The natural vacuum environment may be advantageous as it can create a reliable, consistent, and/or constant vacuum environment. The natural vacuum environment may also be advantageous as it can provide the optimal environment during the use of the molten metal dispensing system 100 in accordance with aspects of this disclosure. For example, the vacuum environment can minimize defects in the deposited material, for example, because the vacuum environment does not include additional elements in the vicinity of the deposited material that could interact with the deposited material.

The structural liner 412 may be coupled or attached to the internal wall 416 of the inflatable bladder 408. An internal surface 413 of the structural liner 412 may define a volume when the inflatable bladder 408 is inflated. The inflatable bladder 408 may include one or more regions 424. For example, the inflatable bladder 408 may include one, two, three, four, fix, six, seven, eight, or more regions 424. The one or more regions 424 may be separated from adjacent regions 424 by one or more walls 428. The one or more walls 428 may extend between the internal wall 416 and the external wall 432. The walls 428 may isolate a region 424 from adjacent regions 424. The one or more regions 424 may be pressurized when the inflatable bladder 408 is inflated. The isolated nature of the one or more regions 424 may reduce a risk that the inflatable bladder 408 fails or becomes non-functional in the event that one or more of the regions 424 are damaged. The inflatable bladder 408 may serve as a multilayer insulation and micrometeoroids and orbital debris (MMOD) protection system. The inflatable bladder 408 can be an elastomeric material. Non-limiting examples include urethane, polyester copolymers, natural rubber, silicone rubber, and fluoropolymers. Once inflated, the pressure exerted on the structural liner 412 by the inflatable bladder 408 can depend on the material properties of the inflatable bladder 408 and/or the material properties of the structural liner 412, including but not limited to the materials selected to form the structural liner 412 and the inflatable bladder 408, the size of the structural liner 412 and the inflatable bladder 408, and the thickness of the materials used to form the structural liner 412 and the inflatable bladder 408. Once inflated, the pressure exerted on the structural liner 412 by the inflatable bladder 408 can be 5, 10, 15, 20, 25, 30, 35, 40 psi, or less, or more, or any value or range defined by any of the preceding values.

The structural liner 412 may be positioned within the internal space 420 defined by the inflatable bladder 408. The structural liner 412 and the inflatable bladder 408 may be capable of moving freely relative to one another. The structural liner 412 may be coupled to the internal wall 416 of the inflatable bladder 408. For example, the structural liner 412 may be adhered to and/or sewn into the internal wall 416 of the inflatable bladder 108. The structural liner 412 may be coupled to the internal wall 416 of the inflatable bladder 408 at specific predetermined locations. For example, the structural liner 412 may be coupled to the internal wall 416 of the inflatable bladder 408 at or near valves that are used for inflating and deflating the inflatable bladder 408. The inflatable bladder 408 and the structural liner 112 may be assembled prior to the deployment or inflation of the inflatable bladder. This may be advantageous when the structure 400 is manufactured in space, as the inflatable bladder 408 and the structural liner 412 in a non-deployed state can be more compact for delivery into space in a kit or as unassembled components to be assembled in space. In addition, since the structure 400 is manufactured in space rather than on Earth, the materials used for manufacturing (the molten metal dispensing system 100, the metal bars 106, etc.) the structure 400 can be split into smaller payloads than the complete structure 400. In this way, a structure 400 that is too large and/or too massive to be launched from Earth can be manufactured in space.

In some embodiments, the structural liner 412 may include a braided carbon fiber liner. Braiding may be used for making large structures using continuous fiber. The use of a braided carbon fiber liner as the structural liner 412 can provide many advantages. For example, the braided carbon fiber liner may be lighter and stronger than liners formed of alternative materials. The lighter and stronger aspects of the braided carbon fiber liner can allow for an advantageous strength to weight ratio in embodiments of the present disclosure. The braided carbon fiber liner being lighter can be advantageous when delivering the materials to space in a kit or as unassembled components to be assembled in space, as it may greatly reduce the overall weight of the kit for shipment to space. Additionally, the relatively light weight of the braided carbon fiber liner may allow for more carbon fiber liner to be used, which may allow for the manufacture of larger structures. Advantageously, the use of braided carbon fiber liner can also provide safety benefits. For example, braided carbon fiber liner can be structurally safer than other liners, as the redundant nature of the braided carbon fiber may tolerate or allow for local failures, while still maintaining the integrity of the assembled structure within acceptable limits. The use of braided carbon fiber liner is also advantageous as the material is not as subject to degradation as alternative materials and therefore may have a longer life. Additionally, the use of braided carbon fiber may reduce or remove the risk of creeping by preventing or limiting the structural liner 412 from undergoing deformation.

It will be understood that embodiments of the present disclosure are not limited to a structural liner 412 including braided carbon fiber, and other materials can be suitably implemented. Other non-limiting examples of materials that can be suitably implemented in the structural liner 412 include a ceramic material or a fiberglass material. The use of a fiberglass material as the structural liner 412 may be advantageous as it may be transparent which may allow for improved transmission of radio frequency waves. Additionally, a liner including fiberglass material may have a better impact resistance that a liner including braided carbon fiber. In some embodiments, the structural liner 412 may include a mix of materials or a combination of more than one material. For example, a mix or combination of braided carbon fiber liner and fiberglass may be suitably implemented in embodiments of the present disclosure. A mix or combination of materials may be advantageous as the structural liner 412 may offer the benefits of both materials.

As shown in FIG. 12, the molten metal dispensing system 100 can be used to deposit a structural shell 414 onto the structural liner 412. For example, the molten metal dispensing system 100 can be used to deposit layers of molten metal on an inner surface of the structural liner 412. Once hardened, the now-solid metal layers will form the structural shell 414 inside the structural liner 412. The molten metal dispensing system 100 can deposit a plurality of layers of molten material to increase the thickness of the resulting structural shell 414. The total thickness of a structure manufactured using the molten metal dispensing system 100 may depend on the particular structure being built. For example, a typical space habitat such as the International Space Station can have a wall thickness of less than about 4 mm. Certain applications can employ metal layers that may not be structural, and thus the metal layers can be relatively thinner, for example, 1 mm to 2 mm, or any value in between these values. For other applications, the molten metal dispensing system 100 can be used to build structural metal parts, which can have locally strengthened area(s) having a thickness of about 50 mm, 75 mm, 100 mm, 125 mm, 150 mm, or any value or range defined by any of the preceding values.

Advantageously, by manufacturing the structural shell 414 in space rather than premanufacturing the structure 400 on Earth, the structure 400 can be manufactured without the need for a modular design. This can increase the size of the structures 400 that are manufactured in space and decrease the manufacturing and/or shipping costs of assembling larger structures 400 in space. Other benefits include the integration of dissimilar materials (for example, the structural liner 412 or other high performance fabric materials and the molten metal dispensed from the molten metal dispensing system 100 to form the structural shell 414), the building of large metallic structures using different materials together, and the reduction of defects by depositing the molten material in a vacuum environment in space.

The thickness of the metallic structural shell 414 is not necessarily drawn to scale and is to aid in describing embodiments of the present disclosure. The relative dimensions and proportions as shown are not intended to limit the present disclosure. The structural liner 412 and the metallic structural shell 414 may become one structural element of the completed structure 400.

The layers of material deposited to form the metallic structural shell 414 may seal the volume defined by the internal surface 413 of the structural liner 412. In some embodiments, the layers of material may not be intended to withstand forces exerted on the structure 400 in a space environment but are sufficiently strong to provide stiffness to the structural liner 412, which may carry the majority of the load and can be more mass efficient. Together, the structural liner 412 and the metallic structural shell 414 can have sufficient rigidity and stiffness to withstand forces exerted on the structure 400 in a space environment (both external to the structure 400 and internal to the structure 400).

The metallic structural shell 414 may provide a rigid structural interior to the structure 400. The metallic structural shell 414 may pneumatically seal the structure 400. The sealing and rigidizing of the structural liner 412 with the metallic structural shell 414 can transform the structure 400 into a permanent habitat capable of use in space. The rigidity of the metallic structural shell 414 may be advantageous as it allows for system integration. For example, the rigidity of the metallic structural shell 414 can allow windows and docking ports to be incorporated in the structure 400. The rigidity of the metallic structural shell 414 may allow for items or structures for internal use to be physically attached to the metallic structural shell 414. Non-limiting examples of items or structures for internal use include shelving, storage space, artwork, and appliances.

The metallic structural shell 414 may have a thickness of about 1.0, 1.1, 1.2, 1.3, 1.4, 1.5, 1.6, 1.7, 1.8, 1.9, 2.0, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, or 4.0 mm or more, or any value or range defined by any of the preceding values. In some embodiments, the thickness of the metallic structural shell may be about 2 mm to about 3 mm, though in some embodiments the thickness may be outside this range. Each layer of material of the metallic structural shell 414 may have a constant thickness or a small variation in thickness. The metallic structural shell 414 may increase in thickness as it is formed.

The use of the structural liner 412 and the metallic structural shell 414 together can allow for the metallic structural shell 414 to be a relatively thin layer (for example, as compared to the overall outer dimensions of the structure 400), which can allow for a faster, more efficient deposition of the metallic structural shell 414. In some embodiments, the structural liner 412 may not be used and the metallic structural shell 414 may be deposited directly on the internal wall 416 of the inflatable bladder 408 (or other suitable structure). If the structural liner 412 is not used, the metallic structural shell 414 may have a thickness of about 1, 2, 3, 4, 5, 6, 7, 8, 9, 10 mm or more, or any value or range defined by the preceding values. In some embodiments, the metallic structural shell 414 may have a thickness between about 1 inch to about 6 inches, though in some embodiments, the metallic structural shell 414 may have a thickness outside this range.

While FIGS. 11 and 12 relate to an embodiment of a structure 400 that may be manufactured in space, aspects of this disclosure are not limited thereto. For example, the molten metal dispensing system 100 can also be used to manufacture structures on Earth. The molten metal dispensing system 100 can also be used to manufacture any metal structure 400 and/or metal parts that can be constructed using additive manufacturing, such as 3D printing. Advantageously, the molten metal dispensing system 100 can provide a much higher deposition rate than other deposition technologies such as a laser powder bed.

### Example Method of Manufacturing Structures in Space

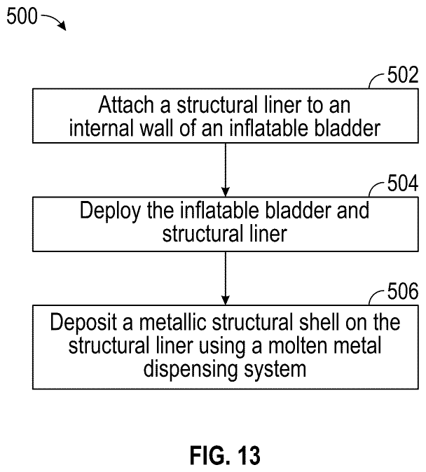

FIG. 13 illustrates a method 500 of manufacturing a structure in accordance with aspects of this disclosure. The methods of manufacturing structures described herein are not limited to manufacturing in space. Accordingly, in some embodiments, the structures may be manufactured on Earth. The methods and structures according to the present disclosure are advantageous, as the structures may be manufactured at or near the location of use, whether that be in space, on Earth, or another planet.

At block 502, the method 500 involves attaching a structural liner (for example, the structural liner 412 of FIGS. 11 and 12) to an internal wall of an inflatable bladder (for example, the inflatable bladder 408 of FIGS. 11 and 12). In some embodiments, the assembled inflatable bladder and structural liner may remain undeployed for transportation. For example, the structural liner may be attached to the internal wall of the inflatable bladder prior to delivering the inflatable bladder to space or other location of use. The undeployed structural liner and inflatable bladder may be packaged in a kit for shipment to space. In one non-limiting embodiment, the kit may be transported to space in a payload fairing of a rocket.

At block 504, the method 500 involves deploying the inflatable bladder and structural liner by pressurizing the inflatable bladder. In some embodiments, the inflatable bladder may be deployed at or near the location of final use. For example, in embodiments where the inflatable bladder is deployed in space, the inflatable bladder may include a connecting port that is connected to a corresponding connecting port of a space station or space vehicle. Once the connecting port of the inflatable bladder and the connecting port of the space station or space vehicle are connected, the inflatable bladder may be deployed.

In some embodiments, pressurizing the inflatable bladder causes the structural liner to be deployed (for example, unfolded or unpacked) because the structural liner is coupled to the inflatable bladder and will adjust and/or conform to the shape and size of the bladder as the bladder is inflated and once it is fully inflated. Pressurizing the inflatable bladder can deploy the structural liner by applying a direct force to external (for example, outer) portions of the structural liner. Advantageously, in some cases, applying a direct force to external portions of the structural liner can obviate or reduce a need to apply a direct force to internal (for example, interior) portions of the structural liner to deploy the structural liner.

In some non-limiting examples, the structural liner is deployed without pressurizing the internal space (for example, the internal space 420 of FIGS. 11 and 12) of the structure. In some embodiments, the inflatable bladder can use much less gas to deploy the inflatable bladder as the one or more regions of the inflatable bladder are much smaller than the entire volume of the structure being formed. During deployment, the internal space of the structure may remain a vacuum. Further, after deployment, the internal space of the structure may remain a vacuum. As a result, embodiments of the structure may not include an external source of gas configured to pressurize the internal space during deployment of the structural liner and may only include an external source of gas configured to pressurize the inflatable bladder during deployment of the structural liner. In such cases, the volume of gas required to deploy the structural liner can be reduced by one or more orders of magnitude. Such effective use of external sources of gas in accordance with the present disclosure can be particularly advantageous in implementations where the structural liner is deployed in space.

At block 506, the method 500 involves depositing a metallic structural shell (for example, the structural shell 414 of FIG. 12) on the structural liner using a molten metal dispensing system according to the present disclosure by moving the molten metal dispensing system over the structural liner. One or more molten metal dispensing systems may be provided within the internal space of the structure, as shown and described in detail with reference to FIGS. 11 and 12, to dispense the molten metal for manufacturing the structural shell.

During formation of the metallic structural shell, the molten metal dispensing system may sequentially deposit a plurality of layers of the molten metal on the structural liner. In embodiments including more than one molten metal dispensing system, the molten metal dispensing systems may be operating simultaneously depositing the metallic layers.

In some embodiments, the molten metal dispensing system includes a channel (for example the channel 120 of FIGS. 1 and 2) extending through a cartridge. The molten metal dispensing system can further include a filter disposed between the channel and the structural liner when the molten metal dispensing system is moved over the structural liner. The filter can include a ceramic material.

In some embodiments, the molten metal dispensing system further includes a front guide configured to prevent molten metal being dispensed through the filter from spreading in undesirable directions, for example in the direction that the molten metal dispensing system is advancing over the structural liner and/or in directions perpendicular to the direction of travel of the molten metal dispensing system.

In some embodiments, the method 500 can further involve feeding a metal bar into the channel of the cartridge, a portion of the metal bar being melted and dispensed through the filter. The melted material can spread throughout the filter as it is deposited on the structural liner. In some embodiments, the structural liner can include a braided carbon fiber liner. In some embodiments, deployment of the inflatable bladder and structural liner can occur in space.

### Terminology

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A molten metal dispensing system comprising:
a cartridge comprising a channel extending from a first end of the cartridge to a second end of the cartridge, the channel configured to receive a metal bar at the second end of the cartridge;
a filter positioned adjacent to the first end of the cartridge;
a heater configured to melt a portion of the metal bar at the first end of the cartridge; and
an actuator configured to apply a force to the metal bar to move the metal bar towards the first end of the cartridge, the movement of the metal bar pushing the melted portion of the metal bar through the filter to dispense the melted portion of the metal bar.

2. The molten metal dispensing system of claim 1, wherein the channel has a rectangular or square cross-section.

3. The molten metal dispensing system of claim 1, wherein the filter has a cross-sectional area that is larger than a cross-sectional area of an opening of the channel at the first end of the cartridge.

4. The molten metal dispensing system of claim 1, further comprising a metal bar holder configured to feed metal bars into the second end of the channel of the cartridge.

5. The molten metal dispensing system of claim 1, further comprising a front guide configured to at least partially contain the melted portion of the metal bar dispensed through the filter.

6. The molten metal dispensing system of claim 5, wherein the front guide is further configured to:
contact a surface of a substrate as the molten metal dispensing system is advanced across the surface of the substrate, and
space the filter apart from the surface of the substrate.

7. The molten metal dispensing system of claim 6, wherein a distance between the filter and the substrate is adjustable.

8. The molten metal dispensing system of claim 5, wherein the front guide has an open end forming a space through which molten metal is dispensed to allow the melted metal to leave the front guide.

9. The molten metal dispensing system of claim 1, wherein the filter comprises a ceramic material.

10. The molten metal dispensing system of claim 9, wherein the filter comprises layers of woven fabric.

11. The molten metal dispensing system of claim 1, wherein the molten metal dispensing system is configured to be advanced across the surface of a substrate to deposit a strip of the melted portion of the metal bar having a thickness of about 1 mm.

12. The molten metal dispensing system of claim 1, wherein the filter is configured to break down a surface tension of the molten metal to dispense a substantially uniform layer of the molten metal on a substrate.

13. The molten metal dispensing system of claim 1, wherein the heater comprises a heating element embedded within a dispensing tip of the cartridge.

14. The molten metal dispensing system of claim 13, wherein the heating element comprises an induction coil or a resistive heater.

15. The molten metal dispensing system of claim 1, wherein the heater comprises a thermometer configured to measure a temperature of the melted portion of the metal bar.

16. The molten metal dispensing system of claim 15, wherein the heater is configured to adjust an amount of heat applied to the metal bar using the temperature measured by the thermometer.

17. The molten metal dispensing system of claim 1, wherein the metal bar comprises a first material, the channel is further configured to receive a second metal bar comprising a second material that is different than the first material, and the heater is configured to heat the first metal bar and the second metal bar to different temperatures.
